(19) United States
(12) Patent Application Publication
(10) Pub. No.: US 2025/0314466 A1
(43) Pub. Date: Oct. 9, 2025

(54) GAS GENERATOR AND FIXING STRUCTURE OF GAS GENERATOR

(71) Applicant: DAICEL CORPORATION, Osaka (JP)

(72) Inventors: Shinya YAMAMOTO, Tokyo (JP); Akira FUKUSHIMA, Tokyo (JP); Narumi MIZUTA, Tokyo (JP)

(73) Assignee: DAICEL CORPORATION, Osaka (JP)

(21) Appl. No.: 19/244,609

(22) Filed: Jun. 20, 2025

Related U.S. Application Data
(63) Continuation of application No. PCT/JP2023/043917, filed on Dec. 7, 2023.

(30) Foreign Application Priority Data
Dec. 22, 2022 (JP) 2022-205944

(51) Int. Cl. F42B 3/04; B60R 22/46

(52) U.S. Cl. CPC F42B 3/04; B60R 22/4628

(57) ABSTRACT

The gas generator includes an ignition device and a case, the case including a side wall portion, an opening portion, and a closing portion closing a tip end side of the side wall portion, the opening portion being connected to the ignition device, closing portion includes, an annular inclination portion connected to the tip end side of the side wall portion, and formed in a funnel shape inclined to radially converge to an inner side of the case from a base end side toward a tip end side, and a lid portion connected to the tip end side of the annular inclination portion, the annular inclination portion and the lid portion are integrally formed, and the lid portion is formed to have a thickness smaller than a thickness of the annular inclination portion, except for an end portion of the lid portion connected to the annular inclination portion.

### CROSS-REFERENCE TO RELATED APPLICATIONS

The present application is a Continuation of International Patent Application No. PCT/JP2023/043917, filed on Dec. 7, 2023, which claims priority from Japanese Patent Application No. 2022-205944, filed on Dec. 22, 2022, the entire contents of each are incorporated herein by reference.

### TECHNICAL FIELD

The present invention relates to a gas generator.

### BACKGROUND ART

There is a proposal for a known gas generator including an outer housing having a receiving part having a cap shape and a cover closing the receiving part. During operation of the gas generator, a gas generating agent in the cover combusts to increase the pressure in the cover, and a part of the cover ruptures to emit the combustion gas (for example, Patent Document 1).

### CITATION LIST

### Patent Document

Patent Document 1: Japanese Patent Application Laid-Open No. 2001-88653

### SUMMARY

### Technical Problem

In a gas generator, there is a method of emitting combustion gas generated due to operation of the gas generator by opening a specific part of a cup to emit the combustion gas. Patent Document 1 described above discloses a structure in which a tear line is provided in a cup, allowing the cup to open along the tear line to emit the combustion gas. However, the thickness of the cup is uniform, which leads to problems that fragments are likely to be formed when the cup ruptures, and it is difficult to concentrate the combustion gas at an opening area.

The technology of the present disclosure has been made in view of the above circumstances, and an object thereof is to provide a gas generator that achieves highly reliable and reproducible opening.

### Solution to Problem

To solve the above problems, the technology of the present disclosure adopts the following configurations. A gas generator according to the present disclosure includes: an ignition device including an igniter and an igniter holding portion configured to hold the igniter in a state of surrounding the igniter; and a case having a bottomed tubular shape and being configured to accommodate a gas generating agent that combusts by an operation of the ignition device, the case including a side wall portion including an opening portion on a base end side and a closing portion configured to close a tip end side of the side wall portion, the opening portion being connected to the igniter holding portion, in which the closing portion includes: an annular inclination portion connected to the tip end side of the side wall portion, and formed in a funnel shape inclined to converge to a radially inner side of the case from a base end side toward a tip end side, and a lid portion connected to the tip end side of the annular inclination portion, the lid portion being orthogonal to an axial direction of the case and being configured to close the tip end side of the annular inclination portion, in the closing portion, the annular inclination portion and the lid portion are integrally formed, and the lid portion is formed to have a thickness smaller than a thickness of the annular inclination portion, except for an end portion of the lid portion connected to the annular inclination portion.

In the above-described gas generator, the annular inclination portion may include an inner surface located on the radially inner side of the case, and an outer surface located on a radially outer side of the case, the inner surface of the annular inclination portion may include an inner-surface base end portion connected to the side wall portion and located on the base end side, and an inner-surface tip end portion connected to the lid portion and located on the tip end side, the outer surface of the annular inclination portion may include an outer-surface base end portion connected to the side wall portion and located on the base end side, and an outer-surface tip end portion connected to the lid portion and located on the tip end side, and in a cross section taken along a central axis of the case, an angle formed between the central axis and an inner-surface imaginary straight line passing through the inner-surface tip end portion and the inner-surface base end portion of the annular inclination portion may be smaller than an angle formed between the central axis and an outer-surface imaginary straight line passing through the outer-surface tip end portion and the outer-surface base end portion of the annular inclination portion.

In the above-described gas generator, a volume of the lid portion may be equal to or smaller than a volume of the annular inclination portion.

In the above-described gas generator, the lid portion may include an inner surface located on a base end side, and an outer surface located on a tip end side, the annular inclination portion may include an inner surface located on the radially inner side of the case, and an outer surface located on the radially outer side of the case, and a corner may be formed by the inner surface of the lid portion, the inner surface of the annular inclination portion, and a boundary line between the inner surface of the lid portion and the inner surface of the annular inclination portion.

In the above-described gas generator, an entirety of the case may be made of resin.

In the above-described gas generator, the igniter holding portion may include a collar made of metal and surrounding an outside of the igniter, and a fixing portion made of resin and interposed between the collar and the igniter, the fixing portion being configured to fix the igniter to the collar, and a base end side of the case may be welded to the fixing portion.

In the above-described gas generator, the inner surface of the annular inclination portion may form a curved surface with a dome shape swelling toward an outside of the case and converging to the radially inner side of the case from the base end side connected to the side wall portion toward the tip end side connected to the lid portion.

In addition, the technology according to the present disclosure may be a fixing structure including: the gas generator described above; and a tubular portion that is an attachment target of the gas generator, in which the tubular portion includes an insertion port into which the gas generator is inserted, the gas generator is fixed to the insertion port in such a manner that the annular inclination portion and the side wall portion of the case face an inner wall surface of the tubular portion, while the lid portion does not face the inner wall surface of the tubular portion, and the gas generator is configured in such a manner that only the lid portion of the case exhibits any of deformation, rupture, burning, or melting due to a pressure generated in the case when the gas generator is attached to the tubular portion and operated.

### Advantageous Effects

According to the present disclosure, it is possible to provide a gas generator that achieves highly reliable and reproducible opening.

### BRIEF DESCRIPTION OF DRAWINGS

FIG. 1 is a perspective view of a gas generator according to a first embodiment.

FIG. 2 is a schematic sectional view taken along the axial direction of the gas generator according to the first embodiment attached to an attachment target.

FIG. 3 is a partially enlarged view of FIG. 2.

FIG. 4 is a partially enlarged view of FIG. 2.

FIG. 5 is a perspective view illustrating a state of the gas generator according to the first embodiment after normal operation.

FIG. 6 is a perspective view of the gas generator according to a modification of the first embodiment.

FIG. 7 is a schematic sectional view taken along the axial direction of the gas generator according to the modification of the first embodiment attached to an attachment target.

FIG. 8 is a partially enlarged view of FIG. 7.

### DESCRIPTION OF EMBODIMENTS

An embodiment of the present disclosure is described below with reference to the drawings. Configurations, combinations thereof, and the like in each embodiment are an example, and additions, omissions, substitutions, and other changes in configuration can be made as appropriate within the scope not departing from the spirit of the present invention. The present disclosure is not limited by the embodiment, and is limited only by the claims.

### First Embodiment

### Device Configuration

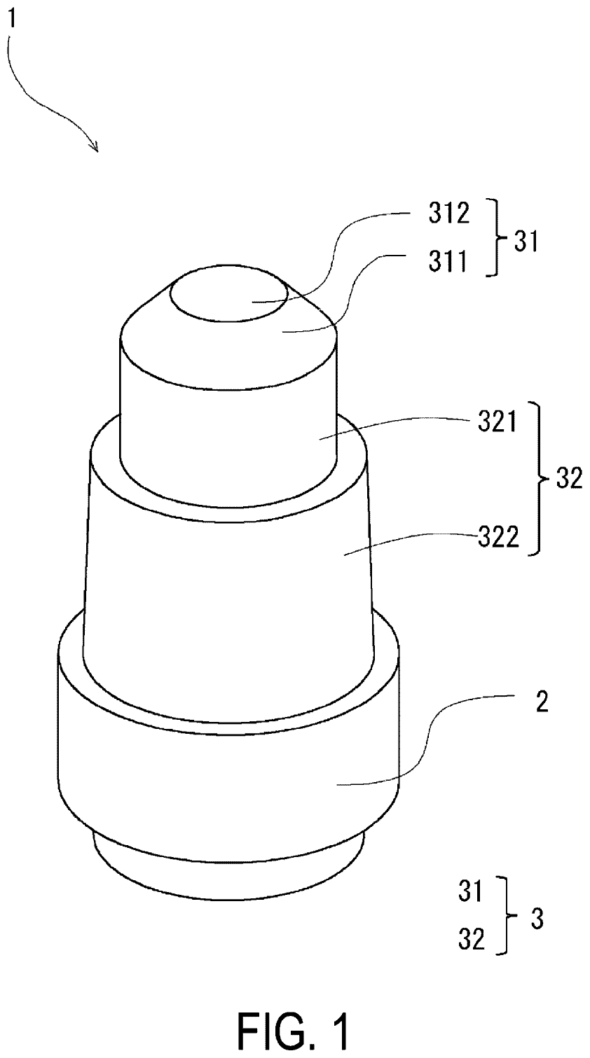

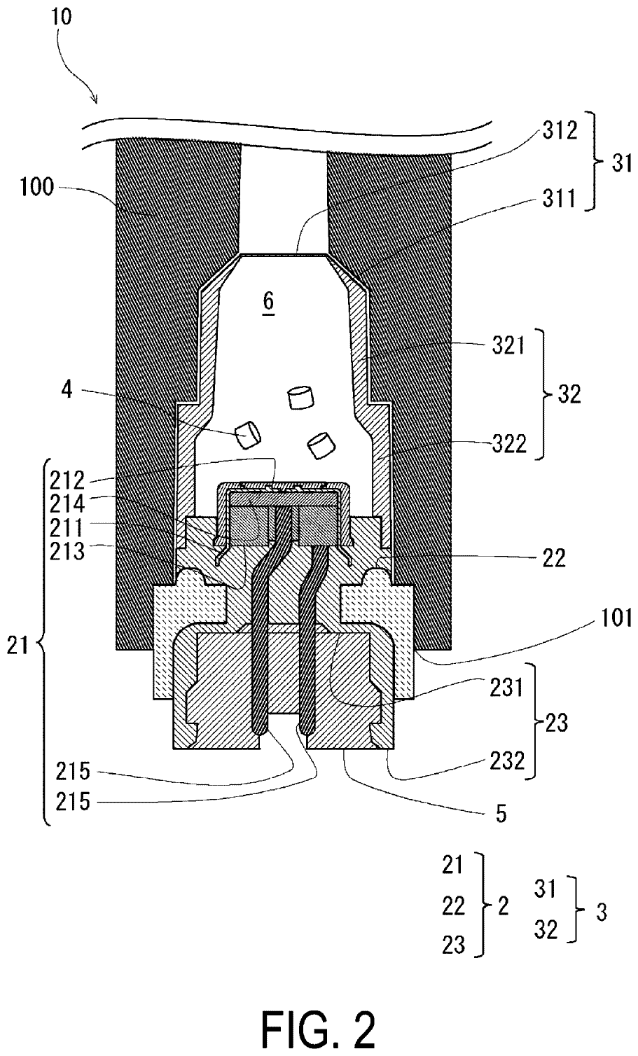

FIG. 1 is a perspective view of a gas generator 1 according to a first embodiment. FIG. 1 illustrates a state of the gas generator 1 before operation. In addition, FIG. 2 is a schematic sectional view taken along the axial direction of the gas generator 1 attached to a tubular portion 100 that is an attachment target. The direction along the axis is described as a height direction (up-down direction) of the gas generator 1. Further, in the height direction of the gas generator 1, an ignition device 2 side is described as a base end side (lower side), and a case 3 side is described as a tip end side (upper side). When operated, the gas generator 1 causes an internal gas generating agent 4 to combust and to release a generated combustion gas to the outside. As illustrated in FIG. 2, the gas generator 1 is incorporated in, for example, a seat belt retractor (pretensioner) 10 of an automobile, and is used to wind up a seat belt in the event of collision of the automobile. The gas generator 1 includes the ignition device 2 and the case 3, and internally accommodates the gas generating agent 4. However, in the present specification, the height direction (up-down direction), the base end side (lower side), the tip end side (upper side), radially outer side, and radially inner side of the gas generator 1 merely indicate a relative positional relationship among the elements of the gas generator 1 for convenience of description of the embodiment.

### Ignition Device

The ignition device 2 includes an igniter 21 that ignites by an ignition current, an igniter holding portion 22 supporting the igniter 21, and a fixing portion 23 interposed between the igniter 21 and the igniter holding portion 22.

The igniter 21 includes, for example, a cup body 211 having a bottomed tubular shape with one end opened, an insulating layer 212, a sealing member 213 closing an opening portion of the cup body 211, an ignition charge 214 accommodated in an ignition chamber formed by the cup body 211 and the sealing member 213, and two electro-conductive pins 215 for receiving supply of a current from the outside. Note that in the present embodiment, for convenience, the cup body 211 side will be described as an upper side, and the electro-conductive pin 215 side will be described as a lower side. The two electro-conductive pins 215 are connected via a bridge wire (not illustrated) in the ignition chamber. When the electro-conductive pins 215 are supplied with a current from the outside, the bridge wire that is a resistor generates heat to combust the ignition charge 214. Note that as the ignition charge 214, an existing ignition charge used in a general gas generator can be adopted. The cup body 211 is a member made of metal covered with the insulating layer 212 made of resin, for example. The sealing member 213 is also made of metal, for example, and the pair of electro-conductive pins 215 are insulated from each other. The cup body 211 has a radial notch (not illustrated) on the upper surface, for example, and is ruptured by a combustion product of the ignition charge 214 to release the combustion product such as flame or combustion gas upward when the igniter 21 is in operation.

In the present embodiment, the igniter holding portion 22 is a metal collar supporting the side of the igniter 21. That is, the igniter holding portion 22 is formed in a tubular shape and holds the igniter 21 therein. Note that to suppress circumferential rotation of the fixing portion 23 with respect to the igniter holding portion 22, an inner peripheral surface of the igniter holding portion 22 in contact with the fixing portion 23 may be provided with recesses and protrusions. The igniter holding portion 22 is fixed, by crimping, to the tubular portion 100 that is an attachment target, which is a seat belt retractor body, for example. The tubular portion 100 is a tubular member having an insertion hole into which the gas generator 1 can be inserted. It should be noted that the igniter holding portion 22 is not limited to a particular member, and, for example, materials other than metal may be used.

The fixing portion 23 is a fixing portion made of resin that is interposed between the igniter 21 and the igniter holding portion 22 by injection molding and that fixes the igniter 21 to the igniter holding portion 22. As a material of the fixing portion 23, a resin material having excellent heat resistance, durability, corrosion resistance, and the like after curing can be suitably used. In the example in FIG. 2, the fixing portion 23 includes a first fixing portion 231 that is located on the upper side and fixes the cup body 211 and the like of the igniter 21, and a second fixing portion 232 that is located on the lower side and mainly surrounds the pair of electro-conductive pins 215. The fixing portion 23 covers the periphery of the side of the igniter 21, and thus, for example, a part of the cup body 211 or the insulating layer 212 is in a state of being exposed from the fixing portion 23. Note that the entirety of the cup body 211 may be overmolded by the fixing portion 23 by omitting the insulating layer 212. By being engaged with the inside of the igniter holding portion 22, the fixing portion 23 fixes the igniter 21 to the igniter holding portion 22. The second fixing portion 232 may fix, inside of the igniter holding portion 22, a connector 5 for supplying the pair of electro-conductive pins 215 with power from an external power source in a state of being connected to the electro-conductive pins 215.

### Case

The case 3 is a bottomed tubular member extending from the base end side toward the tip end side in such a manner that the case 3 surrounds the upper portion of the ignition device 2. The material of the case 3 according to the first embodiment is resin. The case 3 includes a closing portion 31 closing the upper end, and a side wall portion 32 having a tubular shape extending vertically. A combustion chamber 6 accommodating the gas generating agent 4 is formed between the case 3 and the igniter 21. The gas generating agent 4 is ignited by the operation of the igniter 21 and combusted to generate a combustion product such as combustion gas. It should be noted that the material of the case 3 is not limited to resin, but may be a metal such as aluminum, and is not limited to these materials.

The closing portion 31 is formed in a truncated cone shape (funnel shape) with its smaller-diameter circular portion closed. Specifically, the closing portion 31 includes an annular inclination portion 311 connected to the tip end side of the side wall portion 32 extending in the up-down direction, and inclined to converge to the radially inner side of the case 3 from the base end side toward the tip end side, and a lid portion 312 connected to the tip end side of the annular inclination portion 311. The lid portion 312 is orthogonal to the axial direction of the case 3 and closes the tip end side of the annular inclination portion 311. The annular inclination portion 311 and the lid portion 312 are integrally formed.

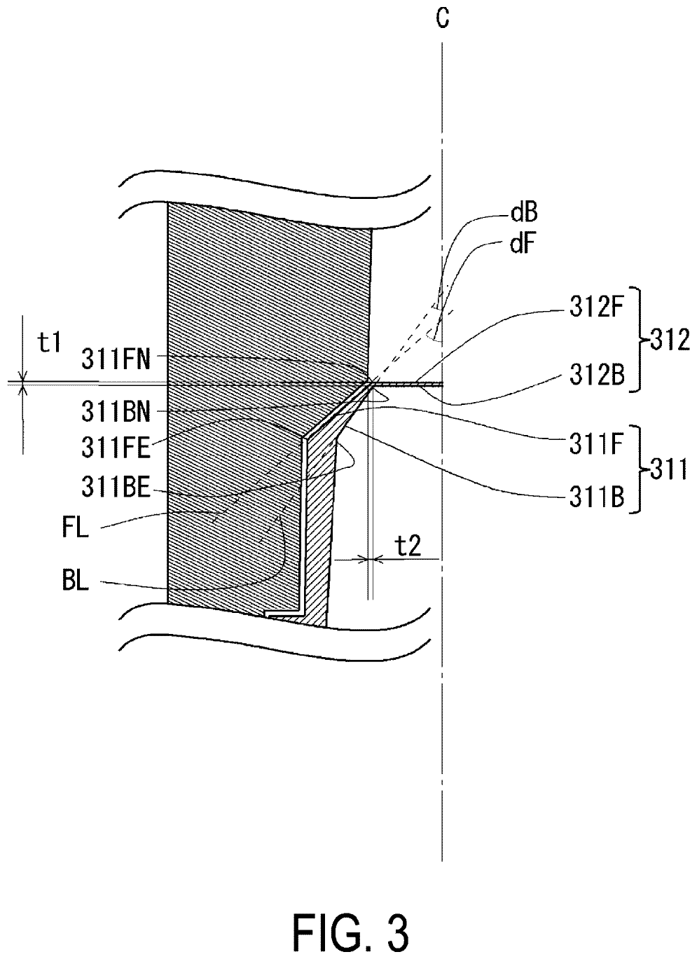

FIG. 3 is a partially enlarged view of FIG. 2 for describing the vicinity of the closing portion 31 of the gas generator 1 according to the first embodiment. The annular inclination portion 311 is made up of an outer surface 311F located on the radially outer side of the case 3, and an inner surface 311B located on radially inner side of the case 3. The lid portion 312 is made up of an outer surface 312F located on the tip end side, and an inner surface 312B located on the base end side. FIG. 3 illustrates a central axis C of the case 3. In the present embodiment, a tip end portion of the outer surface 311F of the annular inclination portion 311 is referred to as outer-surface tip end portion 311FN, and a base end portion of the outer surface 311F of the annular inclination portion 311 is referred to as outer-surface base end portion 311FE. In addition, a tip end portion of the inner surface 311B of the annular inclination portion 311 is referred to as inner-surface tip end portion 311BN, and a base end portion of the inner surface 311B of the annular inclination portion 311 is referred to as inner-surface base end portion 311BE. The annular inclination portion 311 has a truncated cone shape, and each of the outer-surface tip end portion 311FN, the outer-surface base end portion 311FE, the inner-surface tip end portion 311BN, and the inner-surface base end portion 311BE has a circular shape about the central axis C. An angle dF is formed between the central axis C and an outer-surface imaginary straight line FL that is an imaginary straight line passing through the above-mentioned outer-surface tip end portion 311FN and outer-surface base end portion 311FE. In addition, an angle dB is formed between the central axis C and an inner-surface imaginary straight line BL that is an imaginary straight line passing through the inner-surface tip end portion 311BN and the inner-surface base end portion 311BE. The present embodiment has a configuration in which dB is smaller than dF, and the thickness of the annular inclination portion 311 decreases from the base end side toward the tip end side. This can increase the volume in the case 3, and contribute to efficient filling and combustion of the gas generating agent 4. In addition, in a movement path of the combustion gas generated from the gas generating agent 4 having combusted due to the operation of the ignition device 2, a linear gas flow along the inner surface 311B of the annular inclination portion is facilitated in any portion in the circumferential direction, and the combustion gas is smoothly guided to the inner-surface tip end portion 311BN side and the inner surface 312B of the lid portion. This contributes to preventing cracks at portions other than the lid portion 312, and increasing the reliability and reproducibility of rupture of the lid portion 312. Note that in the present embodiment, the thickness of the annular inclination portion 311 gradually decreases toward the lid portion 312, but the annular inclination portion 311 may have a constant thickness as long as the thickness of the lid portion 312 is smaller than that of any portion of the annular inclination portion 311.

The lid portion 312 is made from a circular flat plate. In FIG. 3, the lid portion 312 is made of a circular flat plate with a uniform thickness t1 except at the end portion connected to the annular inclination portion 311. The annular inclination portion 311 has a funnel shape that is inclined to converge to the radially inner side of the case 3 from the base end side toward the tip end side. The annular inclination portion 311 has a configuration in which the thickness decreases from the base end side toward the tip end side as described above. The thickness between the inner-surface tip end portion 311BN of the annular inclination portion and the outer-surface tip end portion 311FN of the annular inclination portion, which is the thinnest portion of the annular inclination portion 311 in the first embodiment, is represented as a thickness t2. The thickness t1 of the lid portion 312 is smaller than the thickness t2 of the annular inclination portion 311 (i.e., t1<t2). Thus, the lid portion 312 has a lower strength than the annular inclination portion 311, and the lid portion 312 preferentially ruptures during the operation of the gas generator 1. The lid portion 312 ruptures by an increase in the internal pressure of the case 3 or by the temperature of the combustion product generated by combustion of the gas generating agent 4. In this manner, in the case 3, the lid portion 312, located on the most tip end side of the closing portion 31, ruptures at the time of combustion of the gas generating agent 4, and a generated gas is emitted to the outside from the lid portion 312. It should be noted that the thickness t1 of the lid portion 312 may be smaller than the thickness of the side wall portion 32 in the case 3 such that the lid portion 312 is the most fragile portion in the case 3.

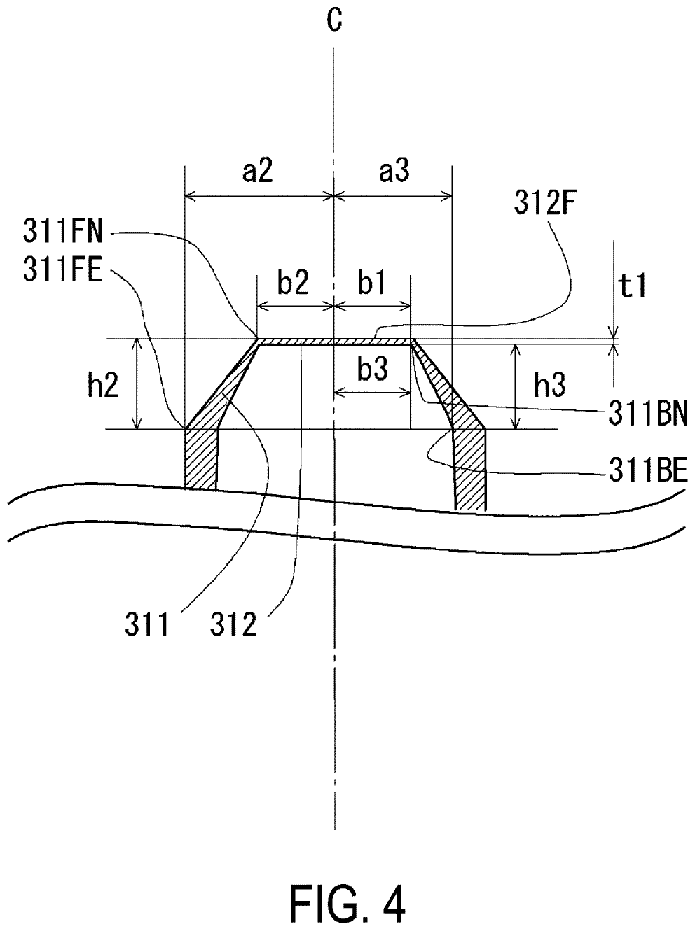

The closing portion 31 is formed such that the volume of the lid portion 312 is equal to or smaller than the volume of the annular inclination portion 311. FIG. 4 is an enlarged view of FIG. 2, and illustrates dimensions used to calculate the volume. In the first embodiment, the volume is calculated as follows. Where the volume of the lid portion 312 is V1, the volume V1 can be calculated as a value obtained by, for example, multiplying the surface area of the outer surface 312F of the lid portion by the thickness t1. The area of the outer surface 312F of the lid portion is calculated using a distance b1 from the central axis C to the circumferential edge of the lid portion 312 (i.e., the radius of the outer surface 312F of the lid portion). V1 can be expressed by the following mathematical expression (1). It should be noted that in the above calculation, a value for the inner surface 312B of the lid portion may be determined instead of the outer surface 312F thereof.

$${V}_{1} = π {b}_{1}^{2} \times {t}_{1} \qquad [ Math . 1 ]$$

A volume V4 of the annular inclination portion 311 is calculated by subtracting a volume V3 of the truncated cone formed by the inner surface 311B of the annular inclination portion 311 from a volume V2 of the truncated cone formed by the outer surface 311F of the annular inclination portion. V4 can be expressed by the following mathematical expression (2).

$${V}_{4} = {V}_{2} - {V}_{3} \qquad [ Math . 2 ]$$

The volume V2 of the truncated cone formed by the outer surface 311F of the annular inclination portion is calculated using a distance a2 from the central axis C to the outer-surface base end portion 311FE of the annular inclination portion 311, and a distance b2 from the central axis C to the outer-surface tip end portion 311FN of the annular inclination portion 311. V2 can be expressed by the following mathematical expression (3).

$${V}_{2} = \frac{1}{3} π {h}_{2} ( {a}_{2}^{2} + {a}_{2} {b}_{2} + {b}_{2}^{2} ) \qquad [ Math . 3 ]$$

The volume V3 of the truncated cone formed by the inner surface 311B of the annular inclination portion 311 is calculated using a distance a3 from the central axis C to the inner-surface base end portion 311BE of the annular inclination portion 311, and a distance b3 from the central axis C to the inner-surface tip end portion 311BN of the annular inclination portion 311. V3 can be expressed by the following mathematical expression (4).

$${V}_{3} = \frac{1}{3} π {h}_{3} ( {a}_{3}^{2} + {a}_{3} {b}_{3} + {b}_{3}^{2} ) \qquad [ Math . 4 ]$$

The volume V4 of the annular inclination portion 311 is calculated by the above calculations. In the present disclosure, the volume V1 of the lid portion 312 is configured to be equal to or smaller than the volume V4 of the annular inclination portion 311.

At the lid portion 312 and the annular inclination portion 311, a corner is formed by the inner surface 312B of the lid portion 312, the inner surface 311B of the annular inclination portion 311, and the boundary line between the inner surface 312B of the lid portion and the inner surface 311B of the annular inclination portion. The expression “a corner is formed” means forming a line at the boundary of two surfaces connected to each other. In the present embodiment, the boundary line is formed as a circumferential portion where the inner-surface tip end portion 311BN and the inner surface 312B of the lid portion are connected. This can concentrate stress of the combustion gas generated during operation of the gas generator 1 at the boundary line, and facilitate rupture of the lid portion 312. Further, in a case where the stress of the combustion gas is to be concentrated at the boundary line between the inner surface 312B of the lid portion and the inner surface 311B of the annular inclination portion 311, the boundary line portion may be formed to have a thickness smaller than the above-mentioned thickness t1 and thickness t2.

The side wall portion 32 is made from a tubular member. In the first embodiment, to form a positioning step described later for the tubular portion 100 that is the attachment target on the outside of the side wall portion 32, the outer diameter of the second side wall portion 322 is larger than the outer diameter of the first side wall portion 321. The base end side of the side wall portion 32 is connected to the fixing portion 23 by full circumference welding, for example. The full circumference welding is annular welding continuous in the circumferential direction, and refers to closing two members of the welding target without a gap.

The side surface of the case 3 has a shape along the radially inner side of the tubular portion 100, which is the attachment target. The shape of the tubular portion 100 on its radially inner side corresponds to the positioning step formed by the difference in outside shape between the first side wall portion 321 and the second side wall portion 322 of the side wall portion 32 of the case 3 described above. This shape restrains the gas generator 1 from being pushed toward the tip end side more than necessary in the tubular portion 100 when the gas generator 1 is inserted into an insertion port 101 of the tubular portion 100. Although not shown in the drawing, a positioning structure for attaching the gas generator 1 to the tubular portion 100, and/or a rotation preventing structure for the gas generator 1 after the gas generator 1 is attached to the tubular portion 100 may be provided. More specifically, the positioning structure and rotation preventing structure may be a fitting structure in which recesses and protrusions formed on any portion of the gas generator 1 (for example, the igniter holding portion 22 or the side wall portion 32 of the case 3, which faces the tubular portion 100), and recesses and protrusions formed on any portion of the inner peripheral surface of the tubular portion 100 are fitted to each other. Due to this, the case 3 is fitted to the tubular portion 100, which is the attachment target of the gas generator 1. In the present embodiment, the gas generator 1 is fixed to the insertion port 101 of the tubular portion 100, which is the attachment target, in such a manner that the side wall portion 32 of the case 3, and the annular inclination portion 311 of the closing portion 31 of the case 3 face the inner wall surface of the tubular portion 100 which is the attachment target, and their peripheries are surrounded, while the lid portion 312 does not face the inner wall surface of the tubular portion 100. Since the inner surface of the tubular portion 100, which is the attachment target, has a shape corresponding to the shape of the outer side of the case 3, rupture of the annular inclination portion 311, and the side wall portion 32 that is the side surface of the case 3 is suppressed even when the internal pressure of the case 3 increases. Since the above-mentioned positioning step is formed on the case 3, when the internal pressure of the case 3 increases, the entire upward ejection of the gas generator 1 and the case 3 is suppressed.

In a state where the gas generator 1 is attached to the tubular portion 100, the inner wall surface of the tubular portion 100 may be in contact with the annular inclination portion 311 and the side wall portion 32 of the case 3 with no gap therebetween. However, since such a design is difficult from the viewpoint of clearance, the gas generator 1 may be disposed with a slight gap of about 0.5 mm to 1 mm formed between the inner wall surface of the tubular portion 100 and the side wall portion 32 of the case 3 and between the inner wall surface of the tubular portion 100 and the annular inclination portion 311. In this manner, during operation, even in a case where the case 3 is deformed due to the pressure of combustion gas, deformation beyond the gap can be prevented. In this case, during operation of the gas generator 1, the side wall portion 32 makes contact with the inner wall surface of the tubular portion 100 due to the deformation of the case 3, thus preventing further deformation, while a load is exerted only on the lid portion 312, which is not restricted by the inner wall surface of the tubular portion 100, thus making the lid portion 312 more likely to rupture.

### Gas Generating Agent

As the gas generating agent 4, a predetermined gas generating agent is used. The combustion temperature of the gas generating agent 4 is, for example, from 1000° C. to 1700° C. The gas generating agent 4 is formed of, for example, guanidine nitrate (41 wt. %), basic copper nitrate (49 wt. %), a binder, and additives. As the individual shape of the gas generating agent 4, a single hole columnar shape can be used. Note that the gas generating agent 4 is not limited to that described above, and a nitrocellulose composition can also be used as the gas generating agent 4.

### Operation

In a state where the gas generator 1 is assembled on a seat belt retractor 10 of an automobile, for example, the connector 5 (a conductive wire is not illustrated) is connected to the two electro-conductive pins 215, and power can be supplied to the igniter 21. In this state, when a sensor (not illustrated) mounted on the automobile or the like senses an impact, the electro-conductive pins 215 are supplied with an ignition current, and the igniter 21 is operated. The igniter 21 causes the ignition charge 214 in the cup body 211 to combust, and thus the combustion product is released to the outside of the cup body 211. The gas generating agent 4 filled in the combustion chamber 6 is ignited by flame or combustion gas that is a combustion product of the ignition charge 214. By being combusted, the gas generating agent 4 generates combustion gas or the like as a combustion product.

The side surface (side wall portion 32) of the case 3 is surrounded over the entire circumference by the tubular portion 100, which is the attachment target, and the inner surface of the attachment target has a shape corresponding to the side surface of the case 3. Thus, rupture of the side surface of the case 3 is suppressed even when the internal pressure of the case 3 increases. Since the outer diameter of the case 3 includes a portion where the tip end side is smaller than the base end side, when the internal pressure of the case 3 increases, the entire upward ejection of the case 3 is suppressed. Therefore, when the internal pressure of the case 3 increases, solely the lid portion 312 of the closing portion 31 ruptures, thus forming an opening. Even if melting of the case 3 occurs due to the temperature of a combustion product, the part to be preferentially melted is limited to the lid portion 312 having a low strength or a part of the lid portion 312. Therefore, scattering of a portion of the case 3 other than the lid portion 312 in the form of small pieces is suppressed. That is, the lid portion 312 which is a rupture portion (the volume of the lid portion 312 which is the rupture portion) is kept small, thus generation of fragments during operation is suppressed. Even if fragments are generated, the size of the fragments can be reduced.

From the opening, the combustion gas is emitted into the seat belt retractor 10 that is an attachment target, for example. Then, the emitted combustion gas causes a predetermined mechanism of the seat belt retractor 10 to operate. Note that as the seat belt retractor 10, an existing configuration may be adopted. For example, the gas generator 1 is connected to one end of a pipe that is a part of the seat belt retractor 10 and moves a steel ball in the pipe by the pressure of combustion gas. The gear is rotated by the moving steel ball, and the seat belt retractor 10 applies the seat belt with pretension by winding the seat belt using the rotation of the gear as a power. At this time, the gas generator 1 includes the lid portion 312 on the tip end side of the closing portion 31 to which the pipe extends, and has such a shape that the side wall portion 32 and the inner surface 311B of the annular inclination portion guide the generated gas to the lid portion 312 side. Thus, a flow of the emitted gas can be concentrated toward the direction of the lid portion 312, and the force can be efficiently transmitted to the seat belt retractor 10.

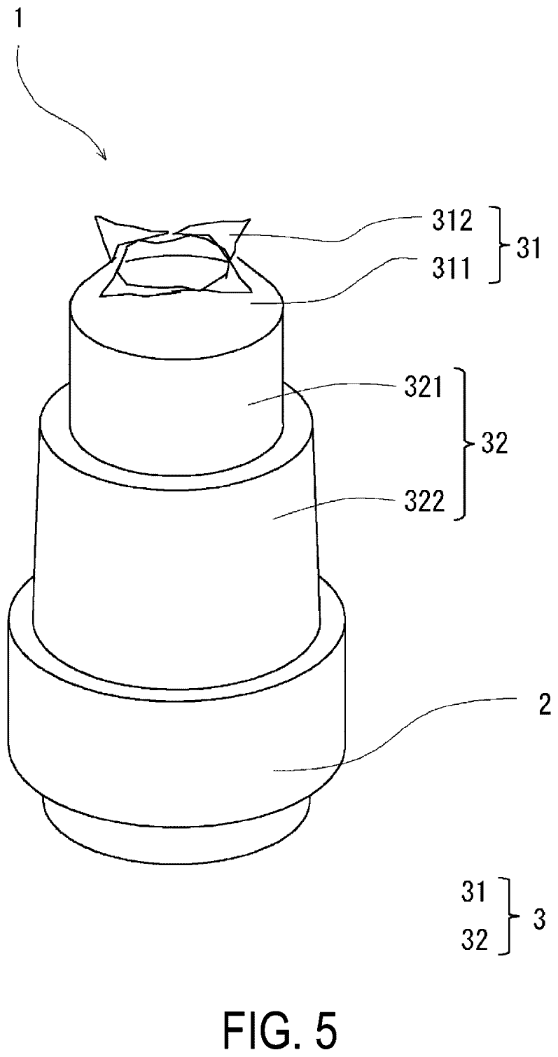

FIG. 5 illustrates the gas generator 1 after being attached to the tubular portion 100 and operated normally. In the case where the gas generator 1 is attached to the tubular portion 100 and operated normally, the case 3 emits combustion gas to the seat belt retractor 10 after rupture of the lid portion 312. The lid portion 312 according to the present embodiment is configured such that only the lid portion 312 ruptures due to the pressure generated in the case 3. In a case where the gas generator 1 is operated without being mounted on the tubular portion 100, the annular inclination portion 311, the side wall portion 32, and other portions may not be able to withstand the operating pressure depending on the material or strength of the case 3. Even in such a case, however, a combination of a gas generator using the technology of the present disclosure with a tubular portion can suppress scattering of the case 3 at the time of rupture. In the present embodiment, the lid portion 312 ruptures due to the pressure generated in the case 3; however, the technology according to the present disclosure is not limited to this. The technology according to the present disclosure may be configured in such a manner that only the lid portion 312 exhibits any of deformation, rupture, burning, or melting due to the pressure generated in the case. In any case, the closing portion 31 includes the annular inclination portion 311, thus facilitating rupture of the lid portion 312.

### Modification of First Embodiment

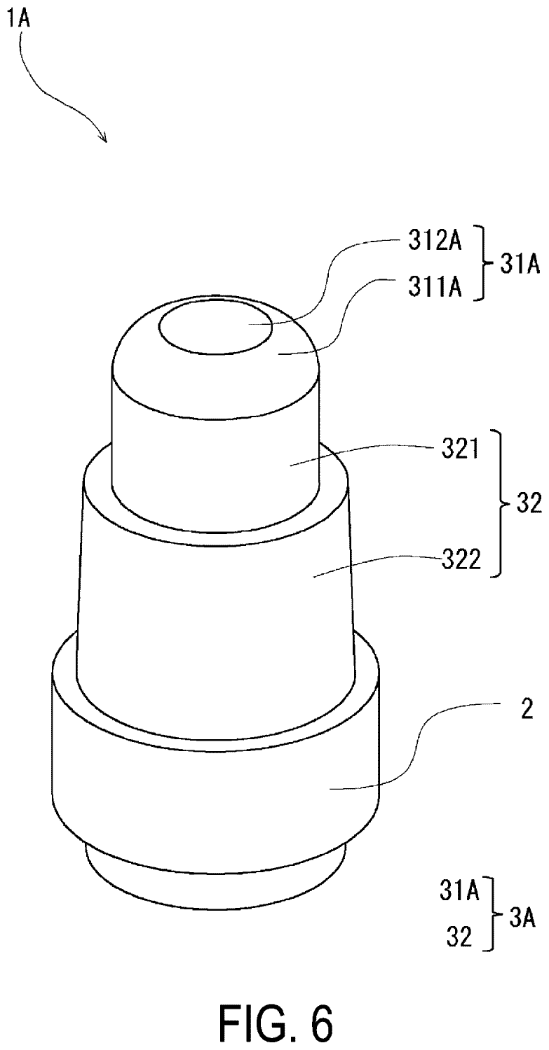

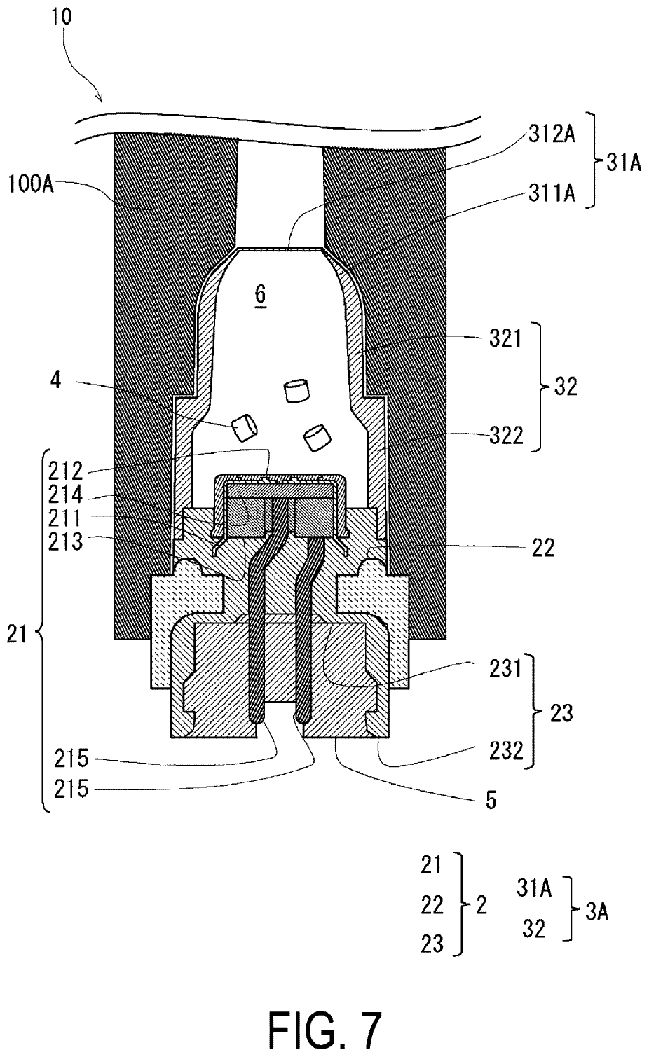

FIG. 6 is a perspective view of a gas generator 1A according to a modification of the first embodiment. FIG. 6 illustrates a state of the gas generator 1A before operation. FIG. 7 is a schematic sectional view taken along the axial direction of the gas generator 1A attached to a tubular portion 100A that is an attachment target. In the present modification, in a closing portion 31A, an annular inclination portion 311A forms a curved surface with a dome shape swelling toward the outside of the case 3A and converges to the radially inner side of the case 3A from the base end side connected to the side wall portion 32 toward the tip end side connected to a lid portion 312A. In addition, among members included in the gas generator 1A, the same members as those of the gas generator 1 are denoted by the same reference numerals, and detailed descriptions thereof will be omitted.

The case 3A is a bottomed tubular member extending from the base end side toward the tip end side in such a manner that the case 3A surrounds the upper portion of the ignition device 2. The material of the case 3A according to the modification of the first embodiment is resin. It should be noted that the material of the case 3A is not limited to resin, but may be a metal such as aluminum, and is not limited to these materials.

The closing portion 31A is formed in a dome shape with its smaller-diameter circular portion closed. Specifically, the closing portion 31A includes the annular inclination portion 311A connected to the tip end side of the side wall portion 32 extending in the up-down direction, and the lid portion 312A connected to the tip end side of the annular inclination portion 311A. The annular inclination portion 311A forms a curved surface with a dome shape swelling toward the outside of the case 3A and converging to the radially inner side of the case 3A from the base end side toward the tip end side. The lid portion 312A is orthogonal to the axial direction of the case 3A and closes the tip end side of the annular inclination portion 311A. In addition, the annular inclination portion 311A and the lid portion 312A are integrally formed.

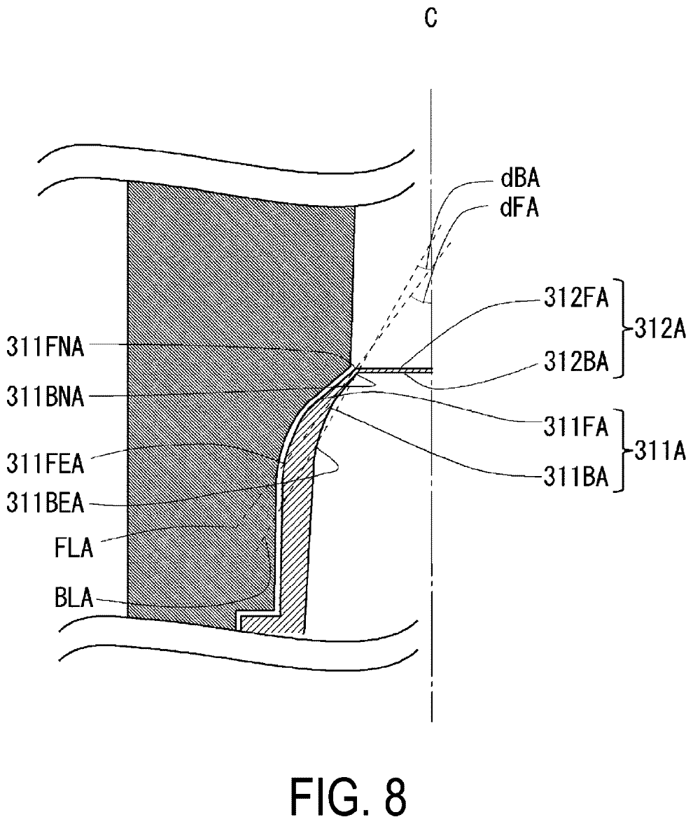

FIG. 8 is a partially enlarged view of FIG. 7 for describing the vicinity of the closing portion 31A of a gas generator according to the modification of the first embodiment. The annular inclination portion 311A is made up of an outer surface 311FA located on the radially outer side of the case 3A, and an inner surface 311BA located on the radially inner side of the case 3A. In addition, the lid portion 312A is made up of an outer surface 312FA located on the tip end side, and an inner surface 312BA located on the base end side. In the modification of the present embodiment, a tip end portion of the outer surface 311FA of the annular inclination portion 311A is referred to as outer-surface tip end portion 311FNA, and a base end portion of the outer surface 311FA of the annular inclination portion 311A is referred to as outer-surface base end portion 311FEA. In addition, a tip end portion of the inner surface 311BA of the annular inclination portion 311A is referred to as inner-surface tip end portion 311BNA, and a base end portion of the inner surface 311BA of the annular inclination portion 311A is referred to as inner-surface base end portion 311BEA. The annular inclination portion 311A has a dome shape, and each of the outer-surface tip end portion 311FNA, the outer-surface base end portion 311FEA, the inner-surface tip end portion 311BNA, and the inner-surface base end portion 311BEA has a circular shape about the central axis C. An angle dFA is formed between the central axis C and an outer-surface imaginary straight line FLA, which is an imaginary straight line passing through the above-mentioned outer-surface tip end portion 311FNA and outer-surface base end portion 311FEA. In addition, an angle dBA is formed between the central axis C and the inner-surface imaginary straight line BLA, which is an imaginary straight line passing through the inner-surface tip end portion 311BNA and the inner-surface base end portion 311BEA. The modification of the present embodiment has a configuration in which dBA is smaller than dFA, and the thickness of the annular inclination portion 311A decreases from the base end side toward the tip end side. This can increase the volume in the case 3A, and contribute to efficient filling and combustion of the gas generating agent 4. In addition, in the movement path of the combustion gas generated from the gas generating agent 4 having combusted due to the operation of the ignition device 2, a gentle gas flow along the inner surface 311BA of the annular inclination portion is facilitated, and smoothly guided to the inner-surface tip end portion 311BNA side and the inner surface 312BA of the lid portion. This contributes to preventing cracks at portions other than the lid portion 312A, and increasing the reliability and reproducibility of rupture of the lid portion 312A. Note that in the modification of the present embodiment, the thickness of the annular inclination portion 311A gradually decreases toward the lid portion 312A, but the annular inclination portion 311A may have a constant thickness as long as the thickness of the lid portion 312A is smaller than that of any portion of the annular inclination portion 311A.

The embodiment of the present disclosure has been described above, and each of the aspects disclosed in the present specification can be combined with any other features disclosed therein.

### REFERENCE SIGNS LIST

1, 1A Gas generator
2 Ignition device
21 Igniter
211 Cup body
212 Insulating layer
213 Sealing member
214 Ignition charge
215 Electro-conductive pin
22 Igniter holding portion
23 Fixing portion
231 First fixing portion
232 Second fixing portion
3 Case
31 Closing portion
311, 311A Annular inclination portion
312, 312A Lid portion
32 Side wall portion
321 First side wall portion
322 Second side wall portion
4 Gas generating agent
5 Connector
6 Combustion chamber
10 Seat belt retractor
100, 100A Tubular portion (attachment target)

1. A gas generator comprising:
an ignition device including an igniter and an igniter holding portion configured to hold the igniter in a state of surrounding the igniter; and
a case having a bottomed tubular shape and being configured to accommodate a gas generating agent that combusts by an operation of the ignition device, the case including a side wall portion including an opening portion on a base end side and a closing portion configured to close a tip end side of the side wall portion, the opening portion being connected to the igniter holding portion, wherein
the closing portion includes:
an annular inclination portion connected to the tip end side of the side wall portion, and formed in a funnel shape inclined to radially converge to an inner side of the case from a base end side toward a tip end side, and
a lid portion connected to the tip end side of the annular inclination portion, the lid portion being orthogonal to an axial direction of the case and being configured to close the tip end side of the annular inclination portion,
in the closing portion, the annular inclination portion and the lid portion are integrally formed, and
the lid portion is formed to have a thickness smaller than a thickness of the annular inclination portion, except for an end portion of the lid portion connected to the annular inclination portion.

2. The gas generator according to claim 1, wherein
the annular inclination portion includes an inner surface located radially on the inner side of the case, and an outer surface located radially on an outer side of the case,
the inner surface of the annular inclination portion includes an inner-surface base end portion connected to the side wall portion and located on the base end side, and an inner-surface tip end portion connected to the lid portion and located on the tip end side,
the outer surface of the annular inclination portion includes an outer-surface base end portion connected to the side wall portion and located on the base end side, and an outer-surface tip end portion connected to the lid portion and located on the tip end side, and
in a cross section taken along a central axis of the case, an angle formed between the central axis and an inner-surface imaginary straight line passing through the inner-surface tip end portion and the inner-surface base end portion of the annular inclination portion is smaller than an angle formed between the central axis and an outer-surface imaginary straight line passing through the outer-surface tip end portion and the outer-surface base end portion of the annular inclination portion.

3. The gas generator according to claim 1, wherein a volume of the lid portion is equal to or smaller than a volume of the annular inclination portion.

4. The gas generator according to claim 1, wherein
the lid portion includes an inner surface located on a base end side, and an outer surface located on a tip end side,
the annular inclination portion includes an inner surface located radially on the inner side of the case, and an outer surface located radially on the outer side of the case, and
a corner is formed by the inner surface of the lid portion, the inner surface of the annular inclination portion, and a boundary line between the inner surface of the lid portion and the inner surface of the annular inclination portion.

5. The gas generator according to claim 1, wherein an entirety of the case is made of resin.

6. The gas generator according to claim 5, wherein
the igniter holding portion includes:
a collar made of metal and surrounding an outside of the igniter, and
a fixing portion made of resin and interposed between the collar and the igniter, the fixing portion being configured to fix the igniter to the collar, and
a base end side of the case is welded to the fixing portion.

7. The gas generator according to claim 1, wherein the inner surface of the annular inclination portion forms a curved surface with a dome shape swelling toward an outside of the case and converging radially to the inner side of the case from the base end side connected to the side wall portion toward the tip end side connected to the lid portion.

8. A fixing structure comprising:
the gas generator according to claim 1; and
a tubular portion that is an attachment target of the gas generator, wherein
the tubular portion includes an insertion port into which the gas generator is inserted,
the gas generator is fixed to the insertion port in such a manner that the annular inclination portion and the side wall portion of the case face an inner wall surface of the tubular portion, while the lid portion does not face the inner wall surface of the tubular portion, and
the gas generator is configured in such a manner that only the lid portion of the case exhibits any of deformation, rupture, burning, or melting due to a pressure generated in the case when the gas generator is attached to the tubular portion and operated.

9. A gas generator comprising:
an ignition device; and
a case accommodating a gas generating agent that combusts by the ignition device, and including,
an open end connected to the ignition device,
a closed end opposite to the open end,
a side wall extending from the open end toward the closed end, and
an annular inclination connected to the closed end and a tip end of the side wall, and formed in a funnel shape inclined to radially converge to an inner side of the case from the tip end of the side wall to the closed end,
the closed end extending orthogonal to an axial direction of the case and being formed integrally with the annular inclination and being provided with a thickness smaller than a thickness of the annular inclination, except for a boundary between the closed end and the annular inclination.

10. The gas generator according to claim 9, wherein
the closed end includes an inner surface facing an inner side of the case and an outer surface facing the outer side of the case,
the annular inclination includes an inner surface located radially on an inner side of the case, and an outer surface located radially on an outer side of the case, and
a corner is formed at the boundary at inner surfaces between the closed end portion and the annular inclination.

11. The gas generator according to claim 9, wherein an entirety of the case is made of resin.

12. The gas generator according to claim 11, wherein
the igniter device includes,
an igniter,
a collar made of metal and surrounding an outside of the igniter, and
a holder made of resin and interposed between the collar and the igniter, the holder is configured to fix the igniter to the collar, and
the open end of the case is welded to the holder.

13. The gas generator according to claim 9, wherein an inner surface of the annular inclination forms a curved surface with a dome shape swelling toward an outside of the case and converging radially to the inner side of the case from the tip end of the side wall to the lid portion.

14. A fixing structure comprising:
the gas generator according to claim 9; and
a tubular portion that is an attachment target of the gas generator, wherein
the tubular portion includes an insertion port into which the gas generator is inserted,
the gas generator is fixed to the insertion port in such a manner that the annular inclination and the side wall of the case face an inner wall surface of the tubular portion, while the closed end does not face the inner wall surface of the tubular portion, and
the gas generator is configured in such a manner that only the closed end of the case exhibits any of deformation, rupture, burning, or melting due to a pressure generated in the case when the gas generator is attached to the tubular portion and operated.
